(19) United States
(12) Patent Application Publication
(10) Pub. No.: US 2010/0085340 A1
(43) Pub. Date: Apr. 8, 2010

(54) Display apparatus

(75) Inventors: Keisuke Omoto, Kanagawa (JP); Junichi Yamashita, Tokyo (JP); Katsuhide Uchino, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/585,881

(22) Filed: Sep. 28, 2009

(30) Foreign Application Priority Data
Oct. 7, 2008 (JP) 2008-260332

(51) Int. Cl. G09G 5/10; G06F 3/038

(52) U.S. Cl. 345/207; 345/690

(57) ABSTRACT

A display apparatus includes a panel in which a plurality of pixels illuminated by self-luminous elements are arranged in a matrix and a photodetector disposed on a back surface of the panel for measuring the luminance of the pixels. Each of the pixels has an aperture portion on a reflective layer provided below a luminous layer, to transmit light emitted from the luminous layer.

### BACKGROUND OF THE INVENTION

1. Field of the Invention

The present invention relates to display apparatuses. In particular, the present invention relates to a display apparatus capable of correcting image sticking with high speed and precision.

2. Description of the Related Art

In recent years, development of flat self-luminous displays employing organic EL (electro-luminescent) devices as light-emitting elements has been accelerated. Organic EL devices have diode characteristics and employ a phenomenon that an organic thin film emits light in response to application of an electric field thereto. An organic EL device can be driven by an applied voltage of 10 V or lower, and thus has low power consumption. In addition, an organic EL device is a self-luminous element that emits light by itself and does not need an illuminator, which allows reduction in the weight and thickness of display apparatuses. Moreover, the response speed of an organic EL device is as very high as several microseconds, which causes no image lag in displaying moving images.

Among flat self-luminous display panels using organic EL devices for the pixels, the development of active-matrix flat self-luminous display panels is significant. Such active-matrix flat self-luminous display panels are disclosed in Japanese Unexamined Patent Application Publications Nos. 2003-255856, 2003-271095, 2004-133240, 2004-029791, and 2004-093682, for example.

### SUMMARY OF THE INVENTION

However, organic EL devices have characteristics that luminous efficiency decreases with increasing light quantity and emission time. Since the luminance of an organic EL device is the product of electric current and luminous efficiency, a decrease in luminous efficiency decreases luminance. It is unlikely that an image composed of the individual pixels having the same appearance will be displayed. In general, the individual pixels have different light quantities. Therefore, even under the same driving conditions, individual pixels exhibit different degrees of decrease in luminance, depending on the light quantity and length of time of light emission in the past. As a result, uneven decrease in the luminance may be visually recognized. This phenomenon is known as image sticking.

There are techniques that have been developed to prevent image sticking in organic EL panels by measuring the luminance of individual pixels and compensating decreases in luminance due to image sticking. However, image sticking compensation techniques according to the related art may not produce sufficient compensation of image sticking.

The present invention has been made in view of the above circumstances. Accordingly, there is a necessity for a technique for performing image-sticking compensation with high speed and precision.

A display apparatus according to an embodiment of the present invention includes a panel in which a plurality of pixels illuminated by self-luminous elements are arranged in a matrix and a photodetector disposed on a back surface of the panel to measure the luminance of the pixels. Each of the pixels has an aperture portion formed on a reflective layer provided below a luminous layer, to transmit light from the luminous layer.

In the display apparatus, each of the pixels includes at least a light-emitting element having a diode characteristic and emitting light in accordance with a drive current, a sampling transistor configured to sample a video signal, a drive transistor configured to supply the drive current to the light-emitting element, and a storage capacitor holding a predetermined potential which is connected to the anode of the light-emitting element and the gate of the drive transistor. The gate electrode of the drive transistor or the sampling transistor is disposed apart from a position right beneath the aperture portion.

According to an embodiment of the present invention, the display apparatus may further include an operation unit configured to calculate compensation data for compensating a decrease in luminance due to pixel aging, on the basis of the luminance of the pixels measured by the photodetector and a drive control unit configured to supply to the pixels the video signal in which a luminance decrease due to pixel aging has been compensated on the basis of the compensation data.

According to an embodiment of the present invention, a panel in which a plurality of pixels illuminated by self-luminous elements are arranged in a matrix and a photodetector disposed on a back surface of the panel to measure the luminance of the pixels are provided. Each of the pixels has an aperture portion formed on a reflective layer provided below a luminous layer to transmit light from the luminous layer.

According to an embodiment of the present invention, image-sticking compensation can be performed with high speed and precision.

### BRIEF DESCRIPTION OF THE DRAWINGS

FIG. 1 is a block diagram illustrating an example of a configuration of a display apparatus according to an embodiment of the present invention;

FIG. 2 is a block diagram illustrating an example of a configuration of an EL panel;

FIG. 3 illustrates an arrangement of colors represented by pixels;

FIG. 4 is a block diagram illustrating a detailed circuit configuration of a pixel;

FIG. 5 is a timing chart illustrating an operation of a pixel;

FIG. 6 is a timing chart illustrating another example of an operation of a pixel;

FIG. 7 is a functional block diagram of a display apparatus relating to image-sticking compensation control;

FIG. 8 is a flowchart illustrating a procedure of initial data acquisition processing;

FIG. 9 is a flowchart illustrating a procedure of compensation data acquisition processing;

FIG. 10 shows schematic cross-sectional and top views of a pixel according to the related art;

FIG. 11 illustrates a difference between a display surface and a back surface of an EL panel in the luminance detected thereon;

FIG. 12 shows schematic cross-sectional and top views of a pixel shown in FIG. 4;

FIG. 13 illustrates the effect of the pattern configuration of the pixel shown in FIG. 12; and

FIG. 14 illustrates the effect of the pattern configuration of the pixel shown in FIG. 12.

### DESCRIPTION OF THE PREFERRED EMBODIMENTS

### Configuration of Display Apparatus

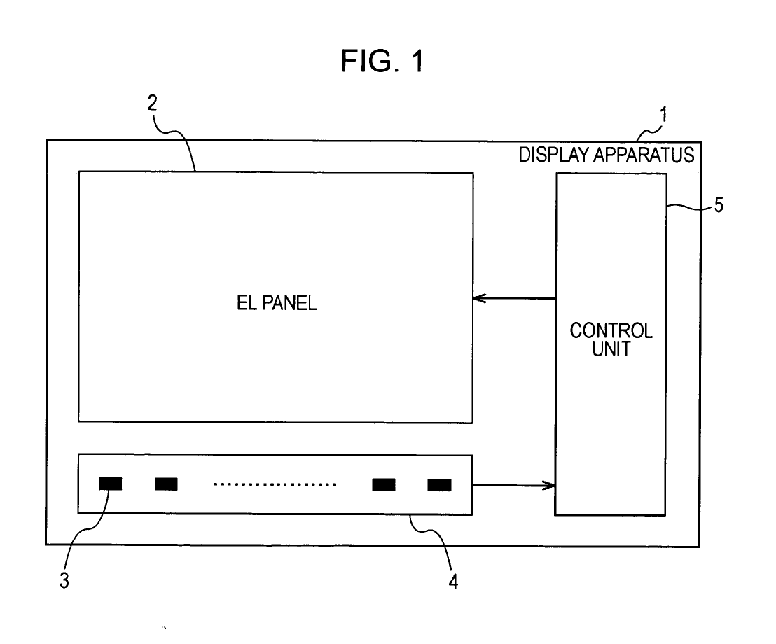

FIG. 1 is a block diagram illustrating an example of a configuration of a display apparatus according to an embodiment of the present invention.

A display apparatus 1 has an EL (electro-luminescent) panel 2, a sensor group 4 composed of a plurality of photodetectors 3, and a control unit 5. The EL panel 2 employs organic EL devices for the self-luminous elements. The photodetectors 3 serve to measure luminance of the El panel 2. The control unit 5 controls display of the EL panel 2 on the basis of the luminance of the EL panel 2 measured by the photodetectors 3.

### Configuration of EL Panel

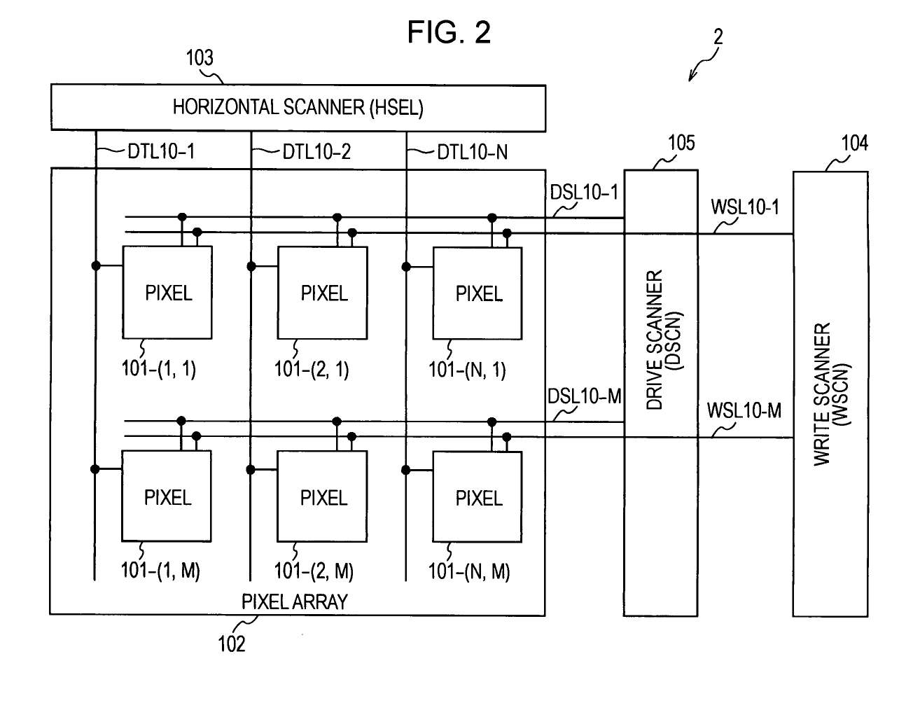

FIG. 2 is a block diagram illustrating a configuration of the EL panel 2.

The EL panel 2 includes a pixel array 102, a horizontal selector (HSEL) 103, a write scanner (WSCN) 104, and a drive scanner (DSCN) 105. The pixel array 102 is composed of pixels (pixel circuits) 101-(1,1) to 101-(N,M) arrayed in an M×N matrix, where M and N are independent integers equal to or greater than 1. The horizontal selector (HSEL) 103, the write scanner (WSCN) 104, and the drive scanner (DSCN) 105 operate as a drive unit for driving the pixel array 102.

The EL panel 2 also has scanning lines WSLs 10-1 to 10-M, drive lines DSLs 10-1 to 10-M, and video signal lines DTLs 10-1 to 10-N.

Hereinafter, the scanning lines WSLs 10-1 to 10-M are simply referred to as the scanning lines WSLs 10 unless it is necessary to distinguish between them. The video signal lines DTLs 10-1 to 10-N are also simply referred to as the video signal lines DTLs 10 unless it is necessary to distinguish between them. Likewise, the pixels 101-(1,1) to 101-(N,M) and the drive lines DSLs 10-1 to 10-M are hereinafter referred to as the pixels 101 and the drive lines DSLs 10, respectively, unless it is necessary to distinguish between them.

Among the pixels 101-(1,1) to 101-(N,M), the pixels 101-(1,1) to 101-(N,1) in the first row are connected to the write scanner 104 and the drive scanner 105 by the scanning line WSL 10-1 and the drive line DSL 10-1, respectively. Among the pixels 101-(1,1) to 101-(N,M), the pixels 101-(1,M) to 101-(N,M) in the M-th row are connected to the write scanner 104 and the drive scanner 105 by the scanning line WSL 10-M and the drive line DSL 10-M, respectively. The other pixels 101 arranged in rows are likewise connected to the write scanner 104 and the drive scanner 105.

Moreover, among the pixels 101-(1,1) to 101-(N,M), the pixels 101-(1,1) to 101-(1,M) in the first column are connected to the horizontal selector 103 by the video signal line DTL 10-1. Among the pixels 101-(1,1) to 101-(N,M), the pixels 101-(N,1) to 101-(N,M) in the N-th column are connected to the horizontal selector 103 by the video signal line DTL 10-N. The other pixels 101 arranged in columns are likewise connected to the horizontal selector 103.

The write scanner 104 sequentially supplies control signals to the respective scanning lines WSLs 10-1 to 10-M in each horizontal period (1H) to line-sequentially scan the pixels 101 on a row-by-row basis. In accordance with the line-sequential scanning, the drive scanner 105 provides a supply voltage of a first potential (Vcc described below) or a supply voltage of a second potential (Vss described below) to the respective drive lines DSLs 10-1 to 10-M. In accordance with the line-sequential scanning, the horizontal selector 103 switches a signal potential Vsig corresponding to a video signal and a reference potential Vofs within each horizontal period (1H) and supplies either of the potentials to the video signal lines DTLs 10-1 to 10-N arranged in columns.

### Arrangement of Pixels 101

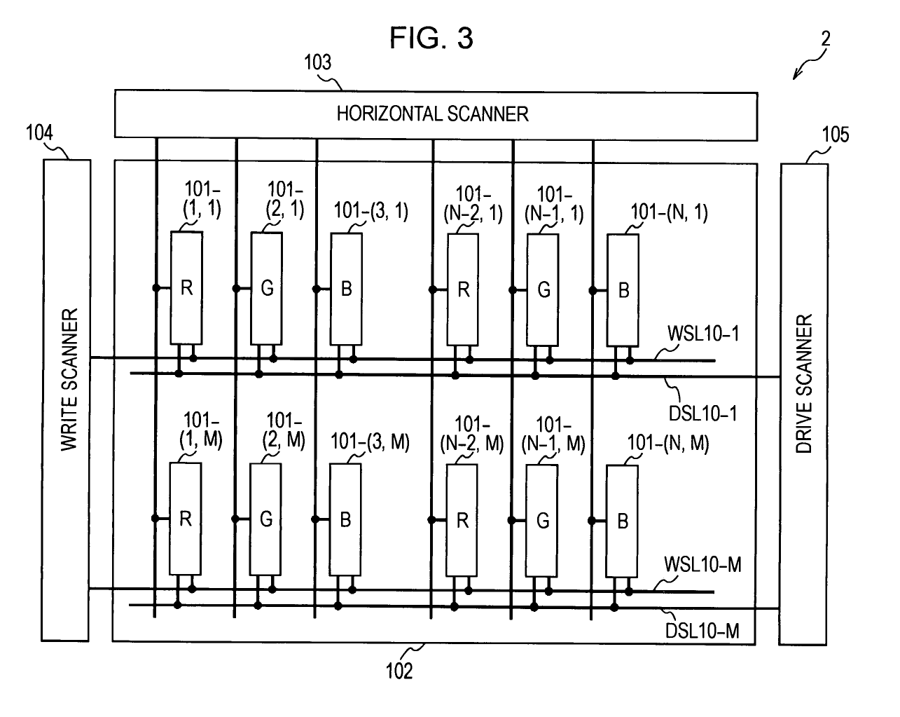

FIG. 3 illustrates colors represented by the individual pixels 101 of the EL panel 2.

Each of the pixels 101 in the pixel array 102 corresponds to a sub-pixel generating either red (R), green (G), or blue (B). Three of the pixels 101 corresponding to R, G, and B arranged in rows (in the left-light direction in the figure) constitute one pixel unit for display.

The arrangement shown in FIG. 3 is different from that shown in FIG. 2, in that the write scanner 104 is provided on the left of the pixel array 102 and that the scanning lines WSLs 10 and the drive lines DSLs 10 are connected to the pixels 101 at their bottom. Wires connecting the horizontal selector 103, the write scanner 104, the drive scanner 105, and the individual pixels 101 may be disposed at appropriate positions.

### Detailed Circuit Configuration of Pixels 101

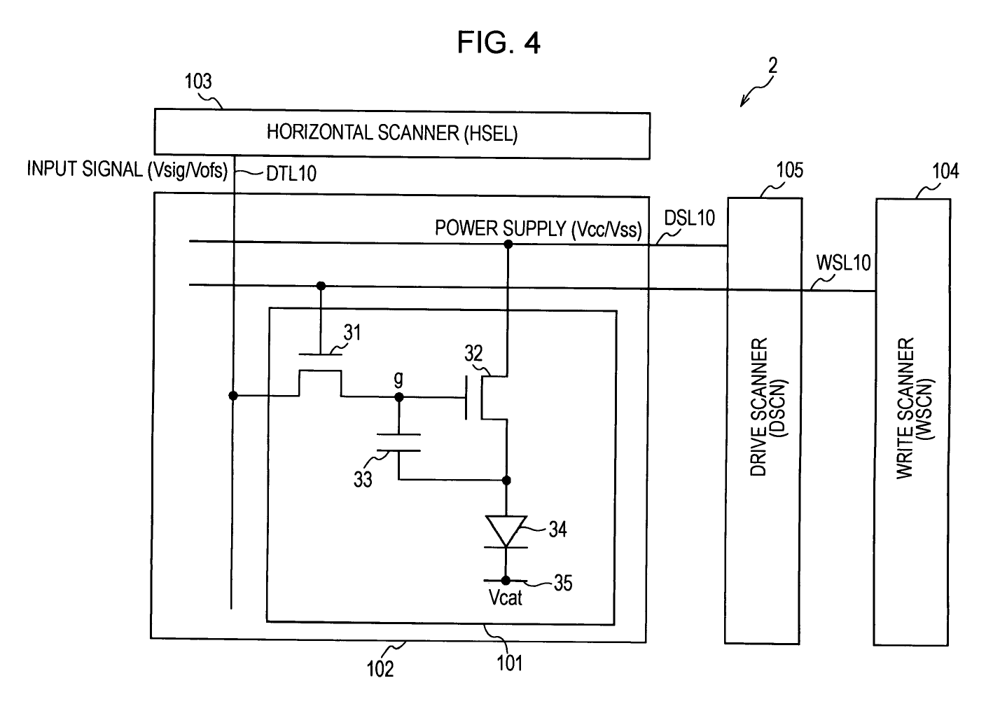

FIG. 4 is a block diagram illustrating in detail a circuit configuration one of the N×M pixels 101 (hereinafter referred to as the pixel 101) included in the EL panel 2.

In FIG. 4, the pixel 101 is connected to corresponding ones of the scanning lines WSLs 10, the video signal lines DTLs 10, and the drive lines DSLs 10. That is, in the case of FIG. 2, the pixel 101-(n,m) (n=1, 2, . . . , N, m=1, 2, . . . , M) corresponds to the scanning line WSL 10-(n,m), the video signal line 10-(n,m), and the drive line DSL 10-(n,m).

The pixel 101 in FIG. 4 has a sampling transistor 31, a drive transistor 32, a storage capacitor 33, and a light-emitting element 34. The gate of the sampling transistor 31 is connected to corresponding one of the scanning lines WSLs 10 (hereinafter referred to as the scanning line WSL 10). The drain of the sampling transistor 31 is connected to corresponding one of the video signal lines DTLs 10 (hereinafter referred to as the video signal line DTL 10). The source of the sampling transistor 31 is connected to the gate g of the drive transistor 32.

Either one of the source or the drain of the drive transistor 32 is connected to the anode of the light-emitting element 34, and the other one is connected to the drive line DSL 10. The storage capacitor 33 is connected to the gate g of the drive transistor 32 and the anode of the light-emitting element 34. The cathode of the light-emitting element 34 is connected to a wire 35 at a predetermined potential Vcat. The potential Vcat is set to GND, and thus the wire 35 is connected to ground.

The sampling transistor 31 and the drive transistor 32 are both N-cannel transistors. Thus, the sampling transistor 31 and the drive transistor 32 may be formed of amorphous silicon, which is less expensive than low-temperature polysilicon. This reduces the manufacturing cost of pixel circuits. Needless to say, the sampling transistor 31 and the drive transistor 32 may also be formed of low-temperature polysilicon, single crystal silicone, or the like.

The light-emitting element 34 is formed of an organic EL element. An organic EL element is a current-driven light-emitting element that exhibits diode characteristics. Thus, the light-emitting element 34 emits light with a grayscale corresponding to the amount of supplied current Ids.

In the pixel 101 having the above configuration, the sampling transistor 31 is turned on (conducts) in response to a control signal supplied through the scanning line WSL 10 and samples a video signal at a signal potential Vsig corresponding to a grayscale through the video signal line DTL 10. The storage capacitor 33 stores and holds charge supplied from the horizontal selector 103 through the video signal line DTL 10. The drive transistor 32 receives a current from the drive line DSL 10 at the first potential Vcc and supplies to the light-emitting element 34 a drive current Ids in accordance with the signal potential Vsig held in the storage capacitor 33. The pixel 101 is illuminated when a predetermined amount of drive current Ids is supplied to the light-emitting element 34.

The pixel 101 is capable of threshold correction. The threshold correction is a function of causing the storage capacitor 33 to store a voltage corresponding to a threshold voltage Vth of the drive transistor 32. By executing the threshold correction function, the effect of the threshold voltage Vth of the drive transistor 32, which contributes to variation between the pixels in the EL panel 2, can be canceled.

In addition to the above threshold correction, the pixel 101 is also capable of mobility correction. The mobility correction is a function of performing correction of the mobility μ of the drive transistor 32 by adjusting the signal potential Vsig to be stored in the storage capacitor 33.

Further, the pixel 101 has a bootstrap function. The bootstrap function allows the gate potential Vg of the drive transistor 32 to be changed in accordance with a change in the source potential Vs. Thus, the bootstrap function can maintain the gate-source voltage Vgs of the drive transistor 32 constant.

### Operations of Pixel 101

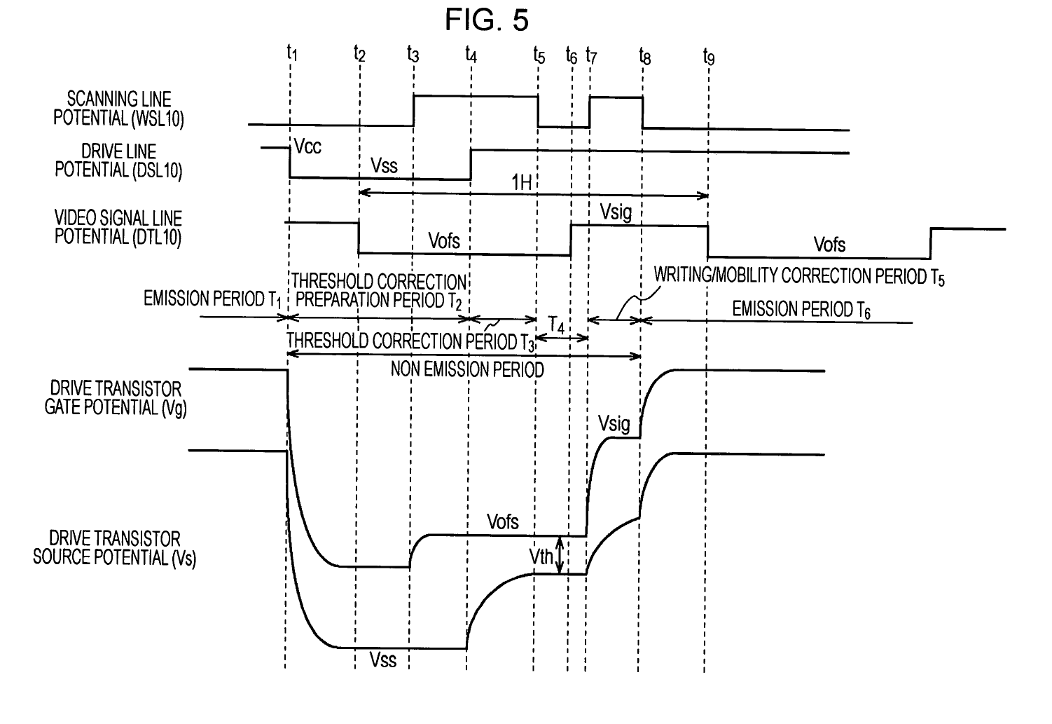

FIG. 5 is a timing chart illustrating an operation of the pixel 101.

FIG. 5 illustrates potential changes in the scanning line WSL 10, the drive line DSL 10, and the video signal line DTL 10 on the same time scale (transverse direction in FIG. 5), and associated changes in the gate potential Vg and the source potential Vs of the drive transistor 32.

In FIG. 5, a period until a time t1 is a light-emission period T1 corresponding to the previous horizontal period (1H).

A period beginning at the time t1, at which the light-emission period T1 ends, and ending at a time t4 is a threshold correction period T2 in which the gate potential Vg and the source potential Vs of the drive transistor 32 are initialized so as to prepare for a threshold voltage correction operation.

In the threshold correction preparation period T2, at the time t1, the drive scanner 105 switches the potential of the drive line DSL 10 from the first potential Vcc, which is a high potential, to the second potential Vss, which is a low potential. Then, at the time t2, the horizontal selector 103 switches the potential of the video signal line DTL 10 from the signal potential Vsig to a reference potential Vofs. At a time t3, the write scanner 104 switches the potential of the scanning line WSL 10 to a high potential so as to turn on the sampling transistor 31. As a result, the gate potential Vg of the drive transistor 32 is reset to the reference potential Vofs, and the source potential Vs is reset to the second potential Vss of the drive line DSL 10.

A time period begging at a time t4 and ending at a time t5 is a threshold correction period T3 in which a threshold correction operation is performed. In the threshold correction period T3, at the time t4, the drive scanner 105 switches the potential of the drive line DSL 10 to the high potential Vcc and a voltage corresponding to the threshold voltage Vth is written to the storage capacitor 33 connected between the gate and source of the drive transistor 32.

In a writing preparation/mobility correction preparation period T4 beginning at the time t5 and ending at a time t7, the potential of the scanning line WSL 10 is switched from the high level to the low level. At the time t6, the horizontal selector 103 switches the potential of the video signal line DTL 10 from the reference potential Vofs to the signal potential Vsig corresponding to a grayscale.

Subsequently, in a writing/mobility correction period T5 beginning at the time t7 and ending at a time t8, writing of a video signal and a mobility correction operation are performed. Specifically, the potential of the scanning line WSL 10 is set at the high level during the period from the time t7 to the time t8. As a result, the signal potential Vsig corresponding to the video signal is added to the threshold voltage Vth and stored in the storage capacitor 33. Further, a voltage ΔVμ for mobility correction is subtracted from the voltage stored in the storage capacitor 33.

At a time t8 subsequent to the writing/mobility correction period T5, the potential of the scanning line WSL 10 is set to the low level, and thus a light emission period T6 begins. Thereafter, the light-emitting element 34 emits light with luminance corresponding to the signal potential Vsig. Since the signal potential Vsig is adjusted on the basis of the voltage corresponding to the threshold voltage Vth and the voltage ΔVμ for mobility correction, the luminance of the light-emitting element 34 to be detected is not influenced by the variation of the threshold voltage Vth and mobility μ of the drive transistor 32.

At the beginning of the light emission period T6, a bootstrap operation is performed, and the gate potential Vg and the source potential Vs of the drive transistor 32 rise while the gate-source voltage (Vgs=Vsig+Vth−ΔVμ) is maintained constant.

At a time t9, which is reached after a predetermined time has elapsed since the time t8, the potential of the video signal line DTL 10 falls from the signal potential Vsig to the reference potential Vofs. In FIG. 5, the period from the time t2 to the time t9 corresponds to a horizontal period (1H).

In the manner described above, each of the pixels 101 in the EL panel 2 can cause the light-emitting element 34 to emit light without being influenced by the variation of the threshold voltage Vth and the mobility μ of the drive transistor 32.

### Another Example of Operation of Pixel 101

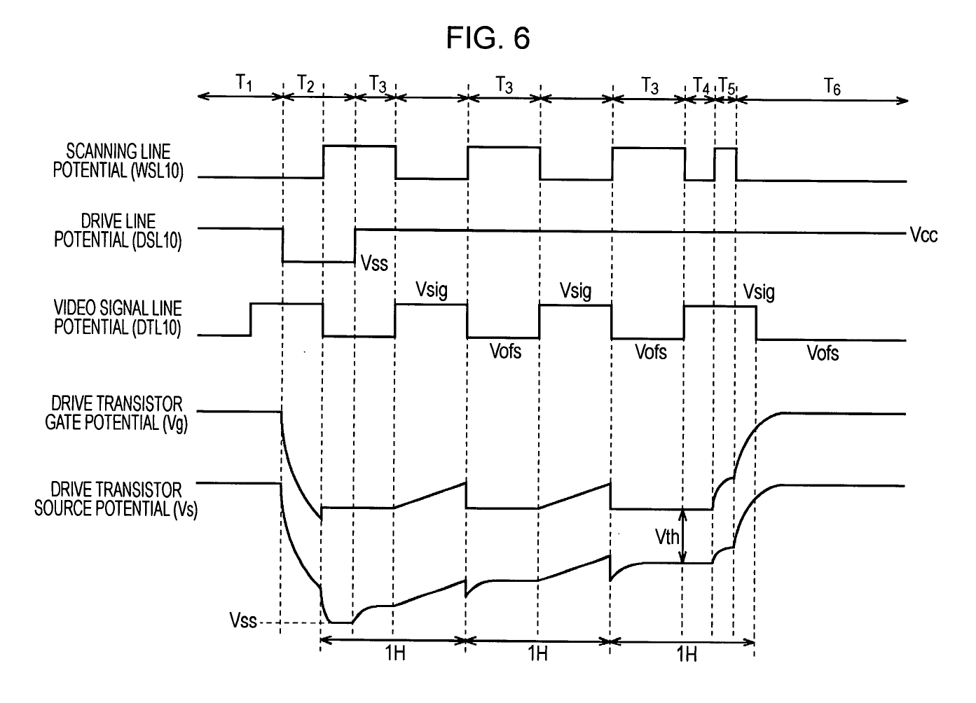

FIG. 6 is a timing chart illustrating another example of an operation of the pixel 101.

In the example illustrated in FIG. 5 described above, a threshold correction operation is performed once in each 1H period. However, when a 1H period is short, it may be difficult to perform threshold correction within the 1H period. In such a case, threshold correction may be performed multiple times over multiple 1H periods.

In the example of FIG. 6, threshold correction is performed over three successive 1H periods (3H periods). That is, the threshold correction period T3 is divided into three parts. Note that except this arrangement, operations of the pixel 101 are similar to those illustrated in FIG. 5, and thus description of the operations will be omitted.

### Functional Block Diagram of Image-Sticking Compensation Control

Meanwhile, an organic EL device has a characteristic that luminance decreases proportionally to increases in light quantity and emission time. It is unlikely that an image composed of the individual pixels 101 having the same appearance will be displayed on the EL panel 2. In general, the individual pixels 101 have different light quantities. Therefore, when a predetermined length of time elapses, difference between the individual pixels 101 in the amount of decrease in luminance efficiency becomes marked, in accordance with the light quantity and emission time of the individual pixels in the past. As a result, under the same drive conditions, a user visually recognizes a phenomenon in which the individual pixels have different luminance as if image sticking has occurred (hereinafter referred to as an image sticking phenomenon). To overcome this image-sticking phenomenon that occurs due to uneven decrease in luminance efficiency between pixels, the display apparatus 1 performs image-sticking compensation control.

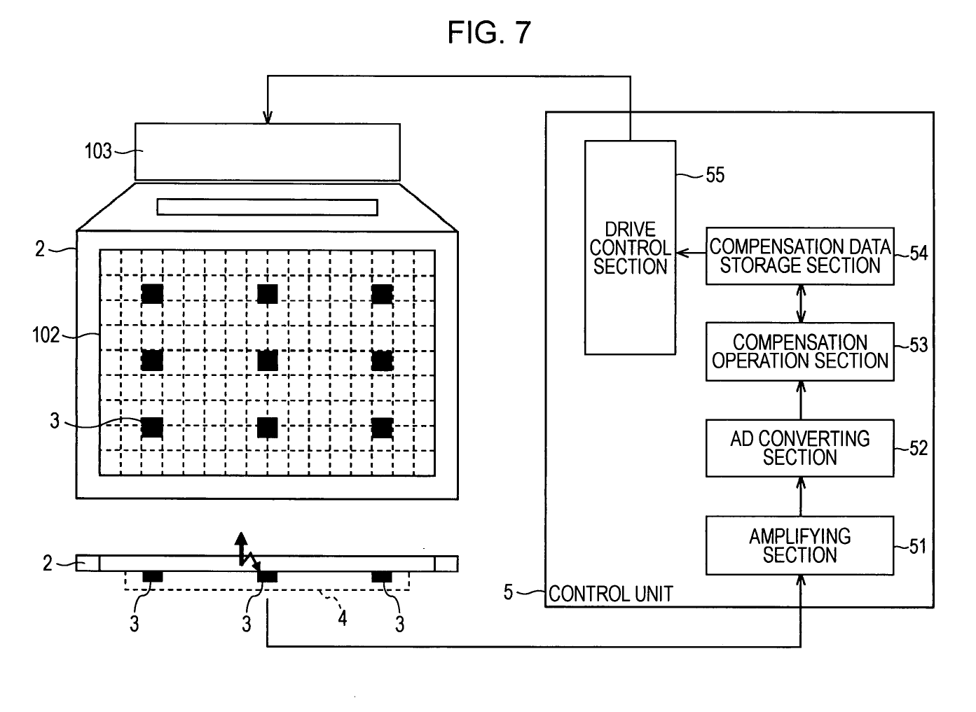

FIG. 7 is a functional block diagram illustrating a functional configuration of the display apparatus 1 which is necessary to perform image-sticking compensation control.

The photodetectors 3 are disposed on the back surface of the EL panel 2 (surface opposite the display surface) so as not to block light emission of the individual pixels 101. The photodetectors 3 are arranged at equal intervals such that a predetermined region includes one of the photodetectors 3. In the example of FIG. 7, the number of the photodetectors 3 constituting a sensor group 4 is nine. However, the number of photodetectors 3 is not limited to nine. Each of the photodetectors 3 (hereinafter also referred to as the photodetector 3) measures luminance of the pixels 101 included in the corresponding region. Specifically, when the pixels 101 in the corresponding region are sequentially illuminated one by one, the photodetector 3 receives incident light reflected from a glass substrate on the front surface of the EL panel 2 and supplies an analog photo-detection signal (voltage signal) dependent on the luminance of the light to the control unit 5.

The control unit 5 is composed of an amplifying section 51, an AD converting section 52, a compensation operation section 53, a compensation data storage section 54, and a drive control section 55.

The amplifying section 51 amplifies an analog photo-detection signal supplied from each of the photodetectors 3 and sends the amplified signal to the AD converting section 52. The AD converting section 52 converts the amplified analog photo-detection signal received from the amplifying section 51 into a digital signal (luminance data) and then sends the digital signal to the compensation operation section 53.

The compensation operation section 53 calculates the amount of luminance decrease in each of the pixels 101 by comparing luminance data obtained in the initial state (at the time of delivery) and luminance data obtained after a predetermined time has passed (after pixel aging occurs), for each of the pixels 101. On the basis of the calculated amounts of luminance decreases, the compensation operation section 53 calculates, for each of the pixels 101, compensation data for compensating the luminance decrease. The calculated compensation data is stored in the compensation data storage section 54. The compensation operation section 53 may be implemented by a signal processing IC such as FPGA (field programmable gate array) and ASIC (application specific integrated circuit).

The compensation data storage section 54 stores compensation data corresponding to the individual pixels 101 calculated by the compensation operation section 53. The compensation data storage section 54 also stores luminance data of the individual pixels 101 in the initial state which is used for a compensation operation.

The drive control section 55 controls the horizontal selector 103 to provide the individual pixels 101 with a signal potential Vsig corresponding to a video signal input to the display apparatus 1. At this time, the drive control section 55 obtains the compensation data corresponding to the individual pixels 101 stored in the compensation data storage section 54 and determines a signal potential Vsig in which the luminance decreases due to pixel aging have been compensated.

### Acquisition Processing of Initial Data of Pixels 101

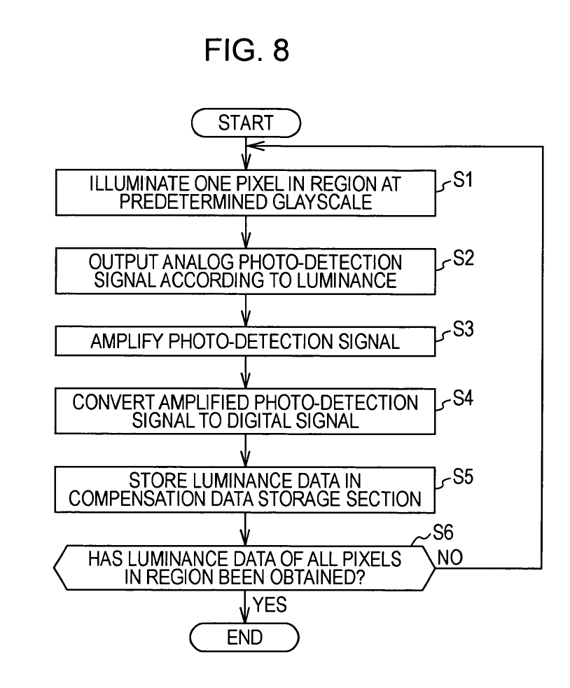

Referring to the flowchart in FIG. 8, a processing procedure for acquiring luminance data of each of the pixels 101 in the pixel array 102 in the initial state will be described. The procedure illustrated in FIG. 8 is performed in parallel in the individual regions corresponding to the photodetectors 3.

At Step S1, the drive control section 55 illuminates one of the pixels 101 in a region of which the luminance data has not been obtained, with a predetermined grayscale value (brightness). At Step S2, the photodetector 3 corresponding to the region supplies an analog photo-detection signal (voltage signal) according to the detected luminance of the pixel to the amplifying section 51 of the control unit 5.

At Step S3, the amplifying section 51 amplifies the photo-detection signal supplied from the photodetector 3 and sends the amplified signal to the AD converting section 52. At Step S4, the AD converting section 52 converts the amplified analog photo-detection signal to a digital signal (luminance data) and sends the converted digital signal to the compensation operation section 53. At Step S5, the compensation operation section 53 sends the received luminance data to the compensation data storage section 54.

At Step S6, the drive control section 55 determines whether luminance data of all of the pixels 101 in the region has been obtained. If it is determined in Step S6 that luminance data of all of the pixels 101 in the region has not been obtained, the processing procedure returns to Step S1 so that the processing from Step S1 to Step S6 is repeated. Specifically, one of the pixels 101 in the region of which the luminance data has not been obtained is illuminated with a predetermined grayscale value so that the luminance data is acquired.

On the other hand, if it is determine in Step S6 that luminance data of all of the pixels 101 in the region has been acquired, the processing procedure is terminated.

### Compensation Data Acquisition Processing

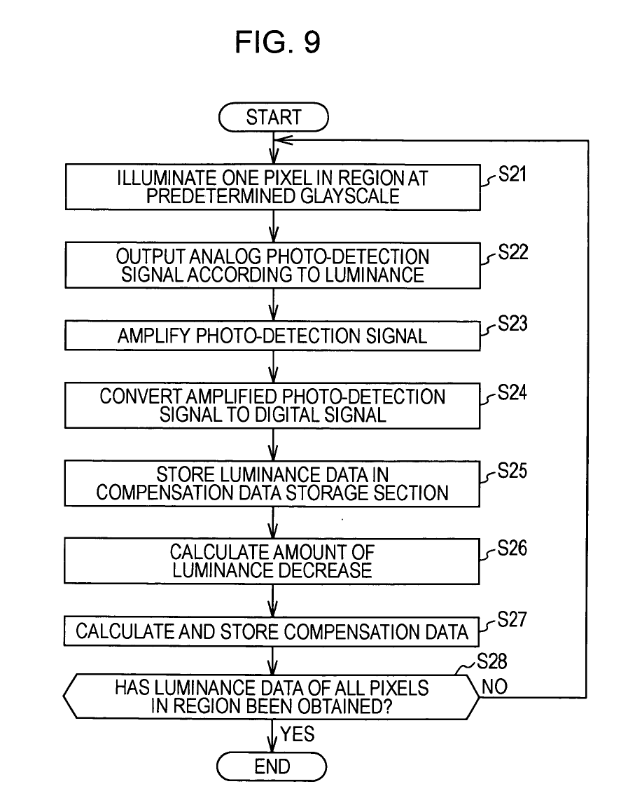

FIG. 9 is a flowchart illustrating a processing procedure for acquiring compensation data which is performed after a predetermined time period has elapsed since the completion of the above processing illustrated in FIG. 8. Similarly to the processing in FIG. 8, this compensation data acquisition processing is performed in parallel in the individual regions corresponding to the individual photodetectors 3.

The processing of Step S21 to Step S24 is similar to the processing of Step S1 to Step S4, respectively, and thus the description thereof will be omitted. That is, in the processing of Step S21 to Step s24, luminance data of the pixels 101 is obtained under the same conditions as the initial data acquisition processing.

At Step S25, the compensation operation section 53 acquires luminous data (initial data) of the pixels 101 on which the initial data acquisition processing has been performed, from the compensation data storage section 54.

At Step S26, the compensation operation section 53 compares the luminous data in the initial state and the luminous data acquired by the processing of Step S21 through Step S24, so as to calculate the amount of luminance decrease in each of the pixels 101. At Step S27, the compensation operation section 53 calculates compensation data on the basis of the calculated amounts of luminance decreases and stores the calculated compensation data in the compensation data storage section 54.

St Step S28, the drive control section 55 determines whether compensation data of all of the pixels 101 in the region has been acquired. If it is determined in Step S28 that compensation data of all of the pixels 101 in the region has not been obtained, the processing procedure returns to Step S21 so that the processing from Step S21 to Step S28 is repeated. Specifically, luminance data of one of the pixels 101 in the region of which the compensation data has not been acquired is acquired.

On the other hand, if it is determined in Step S28 that the compensation data of all of the pixels 101 in the region has been acquired, the processing procedure is terminated.

With the above processing procedures described with reference to FIG. 8 and FIG. 9, compensation data for all of the pixels 101 in the pixel array 102 is stored in the compensation data storage section 54.

After the compensation data is acquired, under the control of the drive control section 55, the signal potential Vsig obtained as a result of compensation of luminance decreases due to pixel aging is supplied to the individual pixels 101 in the pixel array 102. Specifically, the drive control section 55 controls the horizontal selector 103, such that the signal potential Vsig, which is obtained by adding a signal potential calculated from the compensation data to a signal potential corresponding to a video signal input to the display apparatus 1, is supplied to the pixels 101.

The compensation data to be stored in the compensation data storage section 54 may be a value obtained by multiplying a signal potential corresponding to a video signal input to the display apparatus 1 by a predetermined ratio or may be a value offsetting a predetermined voltage, for example. Further, the compensation data may be configured as a compensation table in which compensation data corresponding to signal potentials of a video signal input to the display apparatus 1 is stored. That is, compensation data to be stored in the compensation data storage section 54 may have any form.

In the following, a pattern structure of the pixels 101 will be described. Prior to the description, an example of a pattern structure of pixels according to the related art will be described.

### Pattern Structure of Pixel According to Related Art

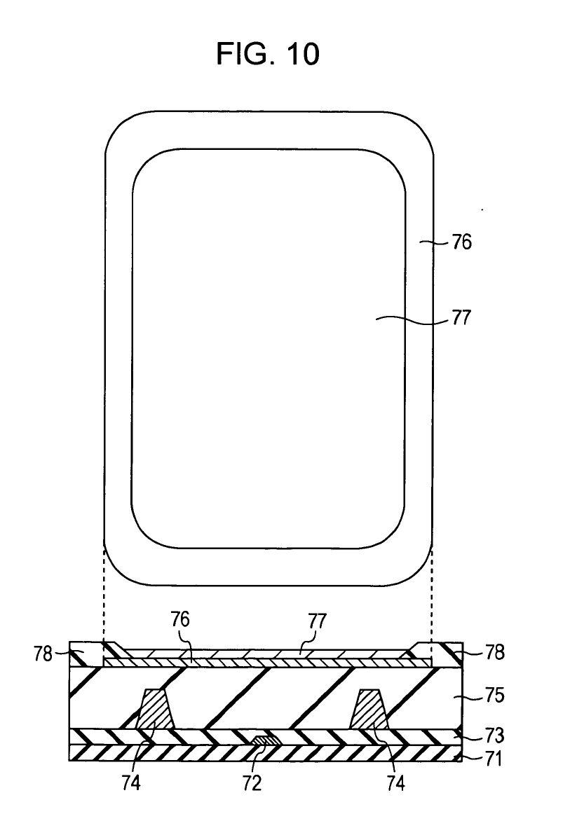

FIG. 10 is a schematic cross sectional view and a top view of a pixel according to the related art.

In the related art, a pixel has gate electrode 72 of the sampling transistor 31 and the drive transistor 32 on a supporting substrate 71 formed of an insulating glass or the like. In addition, an insulating layer 73 is formed on the supporting substrate 71 so as to cover the gate electrode 72.

A metal layer 74 which corresponds to the video signal line DTL 10, the electrodes of the storage capacitor 33, and the like is formed on the insulating layer 73. The metal layer 74 is covered by a planarizing insulating film 75. A reflective electrode 76 is disposed on the planarizing insulating film 75. Further, a luminous layer 77 is disposed on the reflective electrode 76. A planarizing insulating film 78 is formed around the reflective electrode 76.

In this way, the pixel according to the related art is provided with the reflective electrode 76 serving as a reflection film below the luminous layer 77 in order to efficiently output emitted light to the front surface. On the other hand, the photodetectors 3 are disposed on the back surface of the EL panel 2 (below the supporting substrate 71, in the case of FIG. 10). Therefore, luminance to be detected by the photodetectors 3 is much lower than in the case where they are disposed on the side of the display surface.

### Difference Between Display Surface and Back Surface in Detected Luminance

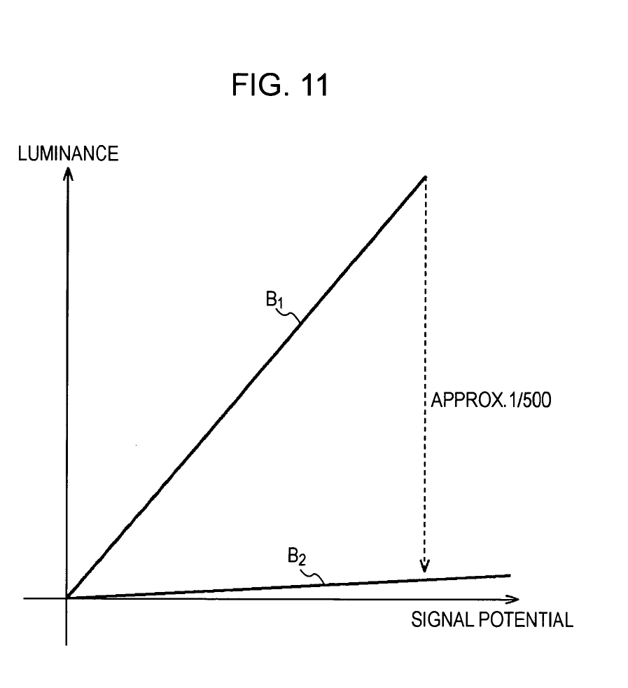

FIG. 11 illustrates a difference between the display surface and the back surface in luminance to be detected thereon. The abscissa in FIG. 11 represents the signal potential Vsig supplied through the video signal line DTL 10 and the ordinate represents the luminance detected by the photodetector 3.

In FIG. 11 a straight line B1 represents the case where the photodetector 3 is disposed on the display surface of the EL panel, and a straight line B2 represents the case where the photodetector 3 is disposed on the back surface of the EL panel. In these two cases, conditions other than the position of the photodetector 3 are set to be the same.

As illustrated in FIG. 11, the luminance that can be detected by the photodetector 3 disposed on the back surface of the EL panel is one five-hundredth of that detected by the photodetector 3 disposed on the display surface.

When the luminance that can be detected by the photodetector 3 is extremely low, the influence of noise such as external light is significant, and thus sufficient precision of compensation operations may not be maintained. In addition, the rise of an output signal of the photodetector 3 is delayed (response time is slow), resulting in an increase in time taken until measurement of luminance is carried out. This results in a short measurement time which may cause measurement to be carried out before the actual luminance is reached, resulting in imprecise correction operations. To solve the above problems, the EL panel 2 employs a configuration different from the configuration shown in FIG. 10.

### Pattern Structure of Pixels 101 in EL Panel 2

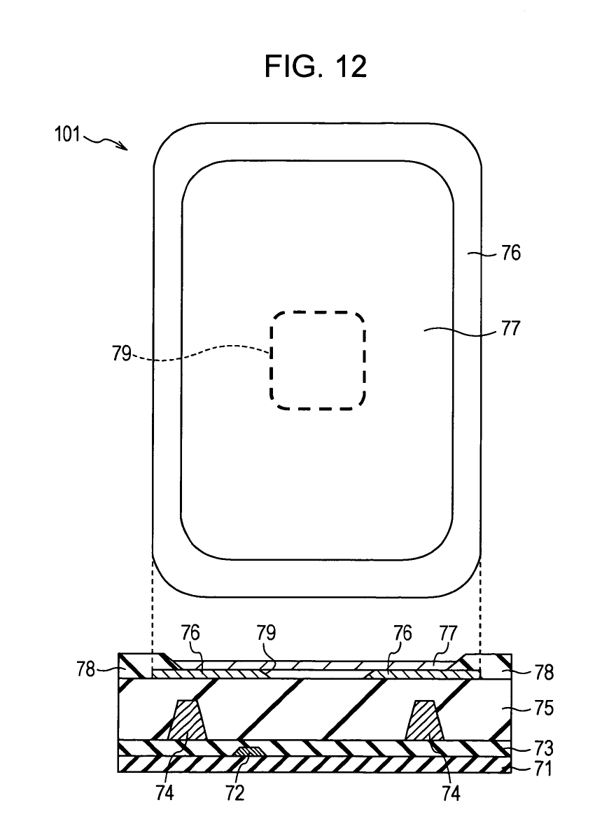

FIG. 12 shows schematic cross-sectional and top views of the pixel 101 depicted so as to be compared with FIG. 10.

In FIG. 12, the description of components configured similarly to those in FIG. 10 will be omitted, and only components having configurations different from those in FIG. 10 will be described.

The pixel 101 is provided with a region in a center portion (indicated by a dotted line) in which no reflective electrode 76 is formed (hereinafter referred to as an aperture portion 79). In other words, the pixel 101 has the aperture portion 79 for transmitting light from the luminous layer 77, in the reflective electrode (reflective film) 76 disposed on the bottom surface of the luminous layer 77. As illustrated in the cross-sectional view, using the planarizing insulating film 78, the aperture portion 79 is formed so as to constitute the same layer as the reflective electrode 76.

Moreover, in the pixel 101 in FIG. 12, the gate electrode 72 is disposed near the metal layer 74 on the supporting substrate 71, whereas in the case of FIG. 10, the gate electrode 72 is formed at a center portion of the supporting substrate 71. In other words, the gate electrode 72, which is a metal film having low transmittance, is disposed apart from a position right beneath the aperture 79 serving as a path of light emitted from the luminous layer 77 toward the back surface.

This arrangement facilitates transmission of light emitted from the luminous layer 77 passing through the aperture portion 79 to the back surface of the EL panel 2. As a result, the detection sensitivity of the photodetectors 3 can further be increased.

### Effect of Pattern Configuration of Pixel 101

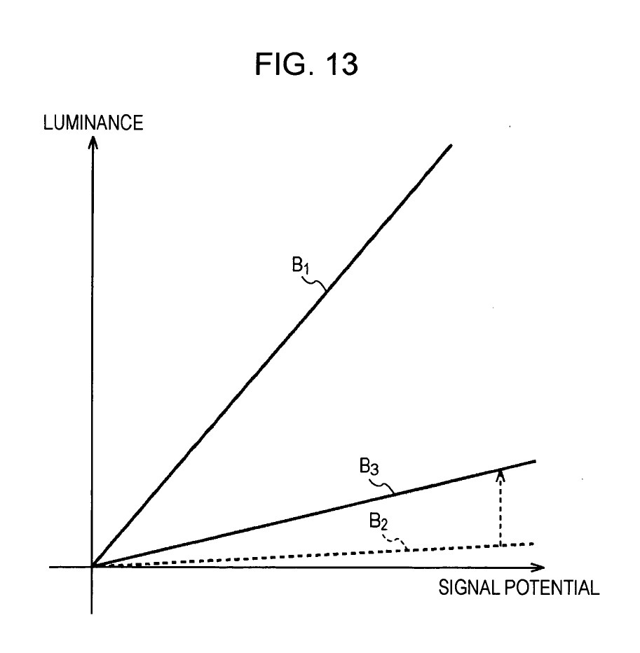

FIG. 13 illustrates the luminance detected by the photodetector 3 on the back surface of the EL panel 2 when the pattern configuration of the pixel 101 is employed.

A straight line B3 represents luminance detected by the photodetectors 3 disposed on the back surface of the EL panel 2 when the pattern configuration of the pixel 101 illustrated in FIG. 12 is employed. As can be seen from the straight line B3, the detection sensitivity is increased by employing the pattern configuration of the pixel 101.

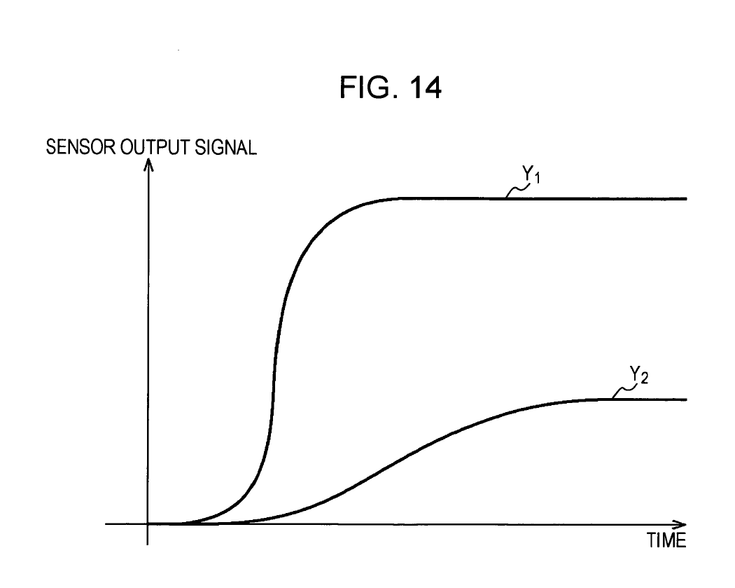

FIG. 14 is a graph for comparison of response speed between the case of the pattern configuration of the pixel according to the related art illustrated in FIG. 10 and the case of the pattern configuration illustrated in FIG. 12.

As indicated by a curve Y1, in the pixel according to the related art, the output level of the photodetector 3 is low, and thus a rise of an output signal of the photodetectors 3 is slow. As a result, a long time is taken to become ready for precise (stable) measurement. On the other hand, as indicated by a curve Y2, the output level of the photodetector 3 is high, indicating a short rise time of an output signal of the photodetector 3. Thus, the length of time taken to be ready for precise (stable) measurement is short.

Accordingly, when the pattern structure of the pixel 101 is employed, the measurement time of luminance can be reduced, compared to the case where the pattern structure according to the related art is employed. In addition, since the output level of the photodetector 3 is high, the influence of noise such as external light can be reduced, which leads to an increase in compensation precision. Thus, according to the EL panel 2 employing the pixels 101, high speed and highly precise image-sticking compensation can be realized.

In the example described above, a planarizing insulating film 78 is provided inside the aperture portion 79. However, it is also possible to provide the luminous layer 77 inside the aperture portion 79. In this case, detection sensitivity of the photodetector 3 disposed on the back surface can further be increased.

### Application of the Preferred Embodiment

It should be noted that the embodiment of the present invention is not limited to the example described above, and various modifications may be made without departing the scope of the present invention.

For example, the pattern structure of the pixels 101 described above may be applied not only to a self-luminous type panel using organic EL devices, but to other self-luminous type panels such as a FED (field emission display).

Moreover, while the pixel 101 is composed of two transistors (i.e., the sampling transistor 31 and the drive transistor 32) and one capacitor (the storage capacitor 33) as described with reference to FIG. 4, other circuit configurations may be employed.

For example, instead of the configuration including two transistors and one capacitor (hereinafter also referred to as a 2Tr/1C pixel circuit), a configuration including five transistors and one capacitor (hereinafter also referred to as a 5Tr/1C pixel circuit) formed by adding first to third transistors may also be employed. When the pixel 101 employs the 5Tr/1C pixel circuit, a signal potential Visg to be supplied from the horizontal selector 103 to the sampling transistor 31 via the video signal line DTL 10 is constant. Consequently, the sampling transistor 31 operates only as a function of switching the supply of the signal potential Vsig between the sampling transistor 31 and the drive transistor 32. In addition, the potential to be supplied to the drive transistor 32 through the drive line DSL 10 is fixed to the first potential Vcc. The added first transistor switches the supply of the first potential Vcc to the drive transistor 32, and the second transistor switches the supply of the second potential Vss to the drive transistor 32. The third transistor switches the supply of a reference potential V of to the drive transistor 32.

Further, it is also possible to employ other circuits having intermediate configurations between a 2Tr/1C pixel circuit and a 5Tr/1C pixel circuit. Specifically, a pixel circuit composed of four transistors and one capacitor (4Tr/1C pixel circuit) or a pixel circuit composed of three transistors and one capacitor (3Tr/1C pixel circuit) may also be employed. In the case of a 3Tr/1C pixel circuit and a 4Tr/1C pixel circuit, the signal potential to be supplied from the horizontal selector 103 to the sampling transistor 31 may be pulsed between Vsig and Vofs. That is, one transistor (third transistor) or two transistors (second and third transistor) may be omitted.

Moreover, to supplement capacitance of an organic luminous material in a 2Tr/1C pixel circuit, a 3Tr/1C pixel circuit, a 4Tr/1C pixel circuit, or a 5Tr/1C pixel circuit, a supplementary capacitor may be added between the anode and the cathode of the light-emitting element 34.

In the above embodiments, processing steps described in the flowcharts may not necessarily be performed in time series according to the described sequence, and may also be performed in parallel or individually.

The above embodiments may be applied not only to the display apparatus 1 illustrated in FIG. 1 but also to various display devices. Display devices to which the above embodiments are to be applied may be displays for displaying video signals input to various electronic apparatuses or generated in the electronic apparatuses as still images or moving images. Such electronic apparatuses may be, for example, digital still cameras, digital video cameras, laptop computers, mobile phones, and television receivers. In the following, examples of electronic apparatuses which employ such display devices will be described below.

One example of the electronic apparatuses to which the present invention may be applied is a television receiver having an image display screen composed of a front panel, a filter glass, and the like. The display apparatus according to the above embodiment are to be used for the image display screen.

Another example of the electronic apparatuses is a laptop personal computer provided with a keyboard in the body which is operated to input characters or the like and a display unit in the cover of the body for displaying an image. The display unit of the laptop personal computer may be constituted by the display apparatus according to the above embodiment.

Further, the above embodiment may be applied to a mobile phone device having an upper housing and a lower housing, as an example of the electronic apparatuses. The mobile phone device may exhibit a state in which the two housing are folded together and a state in which the two housing are unfolded. The mobile phone device also includes a connecting portion (a hinge portion), a display, a sub-display, a backlight, a camera, and the like, and the display apparatus according to the above embodiment can be used for the display or the sub-display.

Furthermore, the above embodiment may also be applied to a digital video camera as an example of the electronic apparatuses. The digital video camera includes a main body, a lens on a front surface for picking up an image of a subject, a start/stop button for image recording, a monitor, and the like. The display apparatus according to the above embodiment can be used for the monitor.

The present application contains subject matter related to that disclosed in Japanese Priority Patent Application JP 2008-260332 filed in the Japan Patent Office on Oct. 17, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus comprising:
a panel in which a plurality of pixels illuminated by self-luminous elements are arranged in a matrix; and
a photodetector configured to measure the luminance of the pixels, the photodetector being disposed on a back surface of the panel,
wherein each of the pixels has an aperture portion configured to transmit light from a luminous layer, the aperture portion being formed on a reflective layer provided below the luminous layer.

2. The display apparatus of claim 1,
wherein each of the pixels comprises at least:
a light-emitting element having a diode characteristic and is configured to emit light in accordance with a drive current;
a sampling transistor configured to sample a video signal;
a drive transistor configured to supply the drive current to the light-emitting element; and
a storage capacitor connected to the anode of the light-emitting element and the gate of the drive transistor, the storage capacitor holding a predetermined potential,
wherein the gate electrode of the drive transistor or the sampling transistor is disposed apart from a position right beneath the aperture portion.

3. The display apparatus of claim 1, further comprising:
an operation unit configured to calculate compensation data for compensating a decrease in luminance due to pixel aging, on the basis of the luminance of the pixels measured by the photodetector; and
a drive control unit configured to supply to the pixels the video signal in which a luminance decrease due to pixel aging has been compensated on the basis of the compensation data.
